(19) United States
(12) Patent Application Publication
(10) Pub. No.: US 2004/0240853 A1
(43) Pub. Date: Dec. 2, 2004

(54) Video signal recording and reproducing system

(76) Inventors: Tetsuo Tsurusaki, Takefu-city (JP); Yoshinori Mizushima, Takefu-city (JP)

Correspondence Address: FLYNN THIEL BOUTELL & TANIS, P.C., 2026 RAMBLING ROAD, KALAMAZOO, MI, 49008-1699, US

(21) Appl. No.: 10/855,129

(22) Filed: May 27, 2004

(30) Foreign Application Priority Data
May 28, 2003 (JP) 2003-151172

(51) Int. Cl. H04N 5/781; G11B 7/085; G11B 21/08

(52) U.S. Cl. 386/95; 386/125

(57) ABSTRACT

An object of the invention is to provide a video signal reproducing system wherein at a time when it is determined in the course of recording or reproduction that contents information is unnecessary, erasing or control for erasing is executed to thereby prevent unnecessary contents information from being accumulated on a recording medium as much as possible, enabling the recording medium to be efficiently utilized without making a wasteful use of a storage capacity of the recording medium. A process flow comprises the steps of detecting whether or not a stop key is operated during a video processing, stopping recording if yes, operating a timer, detecting whether or not the stop key is operated again in a predetermined time, checking whether or not a file sort-out is set to “ON” if the stop key is operated again in the predetermined time, and automatically executing an erase processing of a file being currently recorded, thereby completing the process flow.

### FIELD OF THE INVENTION

The present invention relates to a video signal reproducing device such as a VCR (abbreviation for “Video Cassette Recorder”), DVD (abbreviation for “Digital Versatile Disk” including a video signal reproducing device thereof), HDD (abbreviation for Hard Disk Drive”), and so forth, or a video signal recording and reproducing system combining those devices with each other for integration.

### BACKGROUND OF THE INVENTION

Since progress toward larger capacity of a video signal reproducing device, such as a VCR, DVD, HDD, and so forth, has lately been made, it has become possible to keep contents information of a broadcast program, and so forth, recorded, without concern for a storage capacity of the video signal reproducing device, and to reproduce the information collectively later, thereby executing audio-visual playback. However, there can be a case where a broadcast program other than a preselected broadcast program is recorded due to a setting mistake at a time of preset recording and so forth, or recording is suspended because the contents of a broadcast program are found different from expectation after the start of recording, and so forth, resulting in accumulation of unnecessary contents information on a recording medium. In the case of a digital video signal reproducing device such as the DVD, and HDD, even if a setting mistake is committed at a time of preset recording, and subsequently, recording is started, a file is automatically produced, and even if setting is corrected before resumption of recording, another file is newly produced, so that the file produced due to the setting mistake is not erased and remains accumulated on the recording medium. Further, a broadcast program, the contents of which have already been reproduced for audio-visual playback, and are subsequently not reproduced again after the audio-visual playback, is kept accumulated on the recording medium. Accordingly, unless such contents information as described, which is no longer necessary, is erased whenever necessary, the recording medium will run out of storage space in due course, thereby disabling recording of a new broadcast program. In the case of erasing unnecessary contents information after the recording medium has run out of the storage space, it takes a very troublesome operation to check every piece of information on various contents one by one because a multitude of pieces of information on the various contents are accumulated on a recording medium having a large capacity. With the digital video signal reproducing device, there is the upper limit to the number of files accumulable on a recording medium, so that recording of a new file becomes impossible unless the number of files accumulated is reduced. Accordingly, a list of the files accumulated need be displayed on a screen to be thereby deleted, which takes an operation requiring much expense in time and effort.

To cope with such a problem, in connection with a VTR (Video Tape Recorder), JP-A 9-91927 describes a scheme whereby a storage area of a tape is set so as to be equally divided in time, and counter values corresponding to respective divided areas, and data for identifying whether recorded broadcast programs thereof are necessary or unnecessary are stored, thereby enabling an identification data indicating “unnecessary” to be inputted as necessary, so that unnecessary broadcast programs can be erased at a time, whereupon new broadcast programs can be automatically recorded in areas where unnecessary recorded broadcast programs were stored before. Further, JP-A 2001-60346 describes a scheme whereby when it is determined that an amount of preselected information stored in a memory has reached a predetermined amount, among the preselected information with the elapse of a predetermined time from a planned execution time, pieces of the preselected information are erased in sequence on the basis of first-in first out. Still further, JP-A 2002-44584 describes a scheme whereby a schedule table of virtual channels is displayed, and contents indicating “to be erased” and “audio-visual playback completed”, respectively, are disposed in “past” of the schedule table while contents indicating “reproducible” are disposed in “future” of the schedule table, thereby executing sequential erasing as necessary from the contents disposed in “past” in the case of recording new contents.

As with the cases of JP-A 9-91927, JP-A 2001-60346 and JP-A 2002-44584 described as above, in the case of a device automatically erasing contents information in sequence based on the elapse of time such as time and day of recording and preselect information, there arise problems in that it is unavoidable to erase even necessary contents information as well, and contents information, stored due to a setting error, cannot be erased before the elapse of the predetermined time. Further, in the case of inputting the identification data indicating whether it is necessary or unnecessary, there arises the need for a piece of software for separately setting a storage area for that purpose and executing a new processing.

### SUMMARY OF THE INVENTION

It is therefore an object of the invention to provide a video signal reproducing system wherein at a time when it is determined in the course of recording or reproduction that contents information is unnecessary, erasing or control for erasing is executed by a simple operation to thereby prevent as much as possible unnecessary contents information from being accumulated on a recording medium, thus enabling the recording medium to be efficiently utilized without making a wasteful use of a storage capacity of the recording medium.

The video signal recording and reproducing system of the invention is characterized in comprising recording means for recording contents information on a recording medium, reproduction means for executing reproduction of the contents information recorded on the recording medium, detection means for executing detection on execution of an operation stoppage of the recording means or the reproduction means, determination means for determining whether or not a predetermined key is operated within a predetermined time from the detection on the execution of the operation stoppage, by the detection means, and erasing means for erasing contents information, of which recording or reproduction operation is stopped, from the recording medium on the basis of determination by the determination means that the detection has been made.

Other video signal recording and reproducing system of the invention is characterized in comprising recording means for recording contents information on a recording medium, reproduction means for executing reproduction of the contents information recorded on the recording medium, detection means for executing detection on execution of an operation stoppage of the recording means or the reproduction means, display means for displaying a predetermined verifying screen in response to the detection on the execution of the operation stoppage by the detection means, determination means for determining whether or not a predetermined key is operated within a predetermined time from the detection of the execution of the operation stoppage, by the detection means, and erasing means for erasing contents information, of which recording or reproduction operation is stopped, from the recording medium on the basis of determination by the determination means that the detection has been made.

The still other video signal recording and reproducing system is characterized in comprising recording means for recording contents information on a recording medium, reproduction means for executing reproduction of the contents information recorded on the recording medium, storage means for storing information on a recording position where the recording means or reproduction means have started operation, detection means for executing detection on execution of an operation stoppage of the recording means or the reproduction means, determination means for determining whether or not a predetermined key is operated within a predetermined time from the detection of the execution of the operation stoppage, by the detection means, and position control means for controlling such that the recording medium is set to an operation position corresponding to the information on the recording position on the basis of determination by the determination means that the detection has been made.

The more still other video signal recording and reproducing system is characterized in comprising recording means for recording contents information on a recording medium, reproduction means for executing reproduction of the contents information recorded on the recording medium, storage means for storing information on a recording position where the recording means or reproduction means have started operation, detection means for executing detection on execution of an operation stoppage of the recording means or the reproduction means, display means for displaying a predetermined verifying screen in response to the detection on the execution of the operation stoppage by the detection means, determination means for determining whether or not any suitable key is operated within a predetermined time from the detection of the execution of the operation stoppage, by the detection means, and position control means for controlling such that the recording medium is set to an operation position corresponding to the information on the recording position on the basis of determination by the determination means that the detection has been made.

According to the video signal recording and reproducing system set forth above, the detection means execute the detection of operation of a plurality of keys specifically combined as the predetermined key. Further, the determination means are characterized in that they execute determination processing in the case where the detection means execute the detection on the execution of the operation stoppage, within a predetermined operation time from the start of operation by the recording means or the reproduction means.

With the adoption of such a configuration as described above, if operation of the predetermined key is detected within the predetermined time from the stoppage of recording or reproduction operation, it is possible to erase the contents information of which the recording or reproduction operation is stopped, so that unnecessary contents information can be erased from the recording medium by a very simple operation only at a time when the information is determined unnecessary, thereby enabling the recording medium to be efficiently utilized. Further, every time when it is detected that an operation stoppage of recording or reproduction is executed, determination on erasing is urged by displaying the verifying screen, and upon detecting that any suitable key is operated within the predetermined time, it is possible to erase the contents information of which the recording or reproduction operation is stopped. Accordingly, it is possible to minimize accumulation of unnecessary contents information by calling the user's attention to erasing of contents information all the time, and an erase processing of the unnecessary contents information can be executed by a vary simple operation.

Similarly, by storing information on the recording position where recording or reproduction has been started, and upon detecting that the predetermined key is operated within the predetermined time from the operation stoppage of the recording or the reproduction, position control can be executed in such a way as to set the recording medium to an operation position corresponding to the information on the recording position as stored, so that new contents information can be simply recorded so as to match the information on the recording position of unnecessary contents information as recorded on the recording medium. For example, in the case of a VCR, if information on a recording position where recording or reproduction has been started is stored, this will enable setting such that a tape is automatically rewound to the recording position by operating the predetermined key, so that upon starting recording next, new contents information is written over unnecessary contents information, thereby reducing unnecessary contents information accumulated on the recording medium, and enabling efficient utilization of the tape. Further, by storing the information on the recording position where recording or reproduction has been started, and every time when it is detected that an operation stoppage of the recording or the reproduction is executed, determination on erasing is urged by displaying the verifying screen, and upon detecting that any suitable key is operated within the predetermined time, position control can be executed in such a way as to set the recording medium to the operation position corresponding to the information on the recording position as stored, so that it becomes possible to videotape new contents information so as to correspond to the information on the recording position of unnecessary contents information as described above while calling the user's attention to erasing of contents information all the time.

Further, by executing the erasing or the position control as described above in the case where it is detected that an operation stoppage is executed within a predetermined operation time from the start of the recording or reproduction, it is possible to cause execution of the erasing or the position control to match a timing when the user is highly likely to determine that contents information is unnecessary. For example, if a case is assumed where the contents information is determined unnecessary in the initial stage from the start of the recording or reproduction, by setting the predetermined operation time to a short duration, the verifying screen can be prevented from being displayed in the case of the recording or the reproduction being executed for long hours to some extent. Furthermore, a plurality of keys specifically combined may be used for the predetermined key, thereby preventing the user from erasing necessary contents information by mistake.

### BRIEF DESCRIPTION OF THE DRAWINGS

FIG. 1 is a block diagram broadly showing an embodiment of a video signal reproducing system according to the invention, in its entirety;

FIG. 2 is a process flow sheet showing videotape processing by the embodiment of the invention;

FIG. 3 is a process flow sheet showing reproduction processing by the embodiment of the invention;

FIG. 4 is another process flow sheet showing the videotape processing by the embodiment of the invention;

FIG. 5 is another process flow sheet showing the reproduction processing by the embodiment of the invention;

FIG. 6 is still another process flow sheet showing the videotape processing by the embodiment of the invention;

FIG. 7 is a schematic illustration showing a menu screen by the embodiment of the invention:

FIG. 8 is a schematic illustration showing a file sort-out setting screen by the embodiment of the invention; and

FIG. 9 is a schematic illustration showing a verifying screen in FIG. 6.

### PREFERRED EMBODIMENT OF THE INVENTION

An embodiment of a video signal reproducing system according to the invention is described in detail hereinafter. Although the invention is described with a certain degree of technical particularity since the embodiment described hereinafter is a preferred example for carrying out the invention, it is to be understood that the invention is not limited thereto unless expressly stated otherwise in the following description.

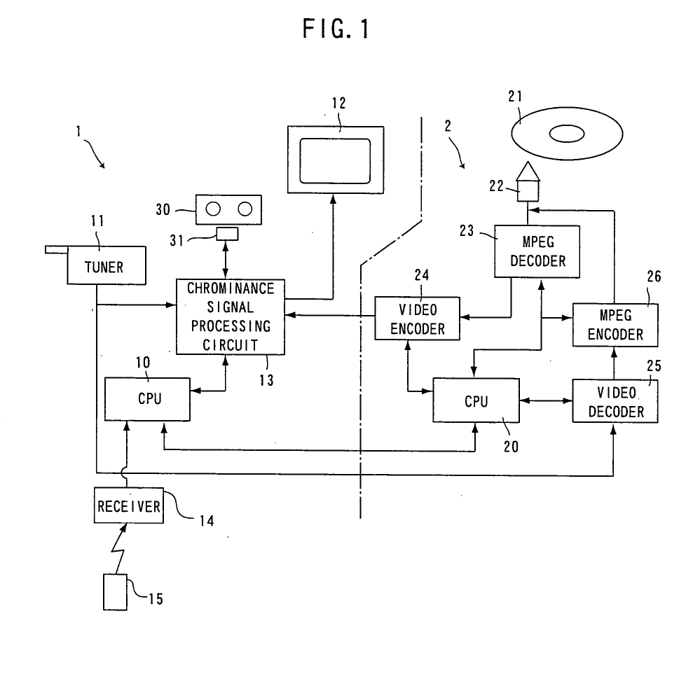

FIG. 1 is a block diagram showing the embodiment of the video signal reproducing system according to the invention, in its entirety. In this example, there is shown a video signal recording and reproducing system combining a block 1 as a function block, incorporating a TV and a VCR, with a HDD block 2 for integration.

Control of the system in whole, and information processing concerning control of TV display and control of recording and reproduction by the VCR are performed by a main body CPU 10 installed in the function block 1 incorporating the TV and VCR, a tuner 11 receives a television broadcast signal from outside, and an output signal from the tuner 11 is processed by a chroma signal processing circuit 13 to be transmitted to a monitor 12 for display control. Further, information recorded on a video cassette 30 is read by a recording head 31, and is processed by the chroma signal processing circuit 13 to be thereby displayed on the monitor 12 as with the case of the television broadcast signal. In the case of recording a television broadcast program, the television broadcast signal delivered from the tuner 11 is processed by the chroma signal processing circuit 13, and is subsequently recorded on the video cassette 30 by the recording head 31.

A receiver 14 is connected to the main body CPU 10, and when a signal, corresponding to a key operated by a user with the use of a remote controller 15, is delivered to the receiver 14, the signal is transmitted to the main body CPU 10 to be thereby processed. As described later, when a stop key is operated with the use of the remote controller 15 after stoppage of recording or reproduction, the main body CPU 10 detects input of such an operation, thereby executing an erase processing or position control of a tape.

Meanwhile, the HDD block 2 has a CPU 20 for executing information processing concerning control of recording and reproduction. Recorded information is read by a pickup 22 from a magnetic disk 21 rotated by a rotation controller (not shown), and is decoded by a MPEG decoder 23. Since decoded information is digital information, the digital information is converted into analog information by a video encoder 24 to be thereby transmitted to the chroma signal processing circuit 13 for display control on the monitor 12. Further, in the case of recording a television broadcast program, a video decoder 25 of the HDD block 2 is connected to the tuner 11, and after converting an analog signal received by the tuner 11 into a digital signal, the digital signal is compressed by a MPEG encoder 26, whereupon processing is executed for recording a compressed signal on the magnetic disk 21 by the pickup 22.

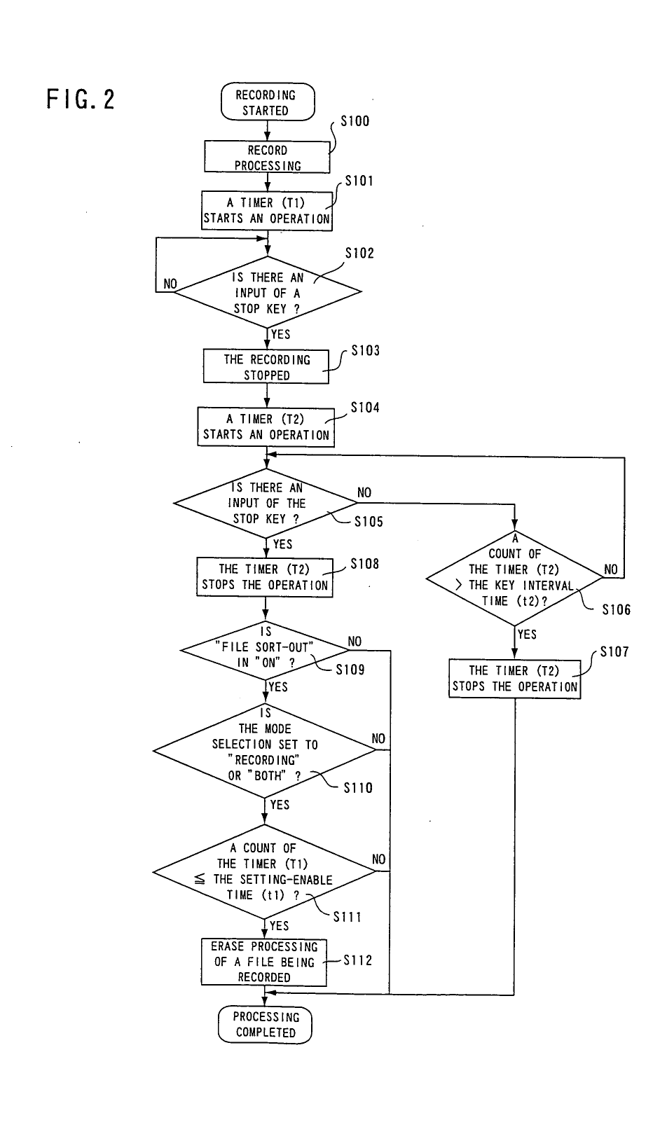

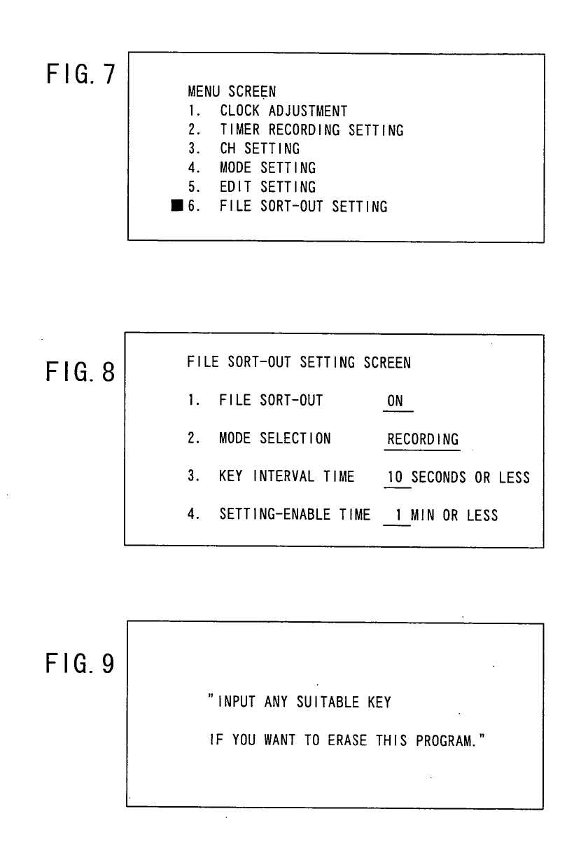

Next, a process flow at a time of recording or reproduction is described. The process flow described hereinafter is executed by the main body CPU 10. FIG. 2 shows an example of the process flow at a time when videotape processing is executed in the HDD block 2. First, presetting concerning sort-out of unnecessary files is executed. As shown in FIG. 7, upon selection of an item “file sort-out setting” as displayed on a menu screen, a file sort-out setting screen shown in FIG. 8 is displayed. In the file sort-out setting screen, setting or release of a file sort-out mode is decided upon by selecting “ON” or “OFF”. In mode selection, “recording”, “reproduction”, or “both” can be selected. The case of setting the file sort-out mode can be limited to only a time of either a videotape processing or reproduction processing, or setting to a case of either of the processings can be executed. In setting of a key interval time, it is possible to set magnitude of time elapsed from the operation of a first key, within which a next key is operated, in order to execute the file sort-out. In this example, the magnitude of the time is set to not more than 10 seconds. In setting of “setting-enable time”, it is possible to preset magnitude of time elapsed from the start of recording, up to when the file sort-out is set. No input of the setting-enable time is required in the case of executing the file sort-out all the time.

After completion of the setting as above, and upon the start of recording as shown in FIG. 2, the main body CPU 10 executes videotape processing (step S100) while a timer (T1) starts operation (step S101). The timer (T1) operates to determine whether or not it is within time as inputted in “setting-enable time” in FIG. 8. Then, detection on whether or not there is a stoppage operation of recording is executed (step S102) and when the stop key is operated by the remote controller 15, the stoppage operation is detected, thereby stopping the recording (step S103). Upon detection of the stoppage of the recording, a timer (T2) starts an operation (step S104). After the start of the operation of the timer (T2), detection on whether or not there is an input of the stop key as a predetermined key in this example is executed (step S105), and in case there is no input thereof, checking on whether or not a count of the timer (T2) exceeds the key interval time (t₂) as set in FIG. 8 is executed (step S106). In case the count does not exceed the key interval time (t₂), the processing reverts to the step (S105), thereby detecting whether or not there is the input of the stop key.

Thereafter, if the count of the timer (T2) exceeds the key interval time (t₂) without the input of the stop key, the operation of the timer (T2) is stopped (step S107), thereby completing the processing.

If the input of the stop key is detected before the count of the timer (T2) exceeds the key interval time (t₂), the operation of the timer (T2) is stopped (step S108), and checking on whether or not the file sort-out as set in the file sort-out setting screen shown in FIG. 8 is in “ON” is executed (step S109), completing the processing in case the same is not in “ON”. If the same is set to “ON”, checking on whether or not the mode selection is set to “recording” or “both” is executed (step S110), completing the processing if not. If the mode selection is set to “recording” or “both”, checking on whether or not a count of the timer (T1) is within the setting-enable time (t₁) as set in FIG. 8 is executed (step S111), completing the processing as it is if not. If the count of the timer (T1) is within the setting-enable time (t₁), erase processing of a file being currently recorded is executed (step S112), thereby completing the processing.

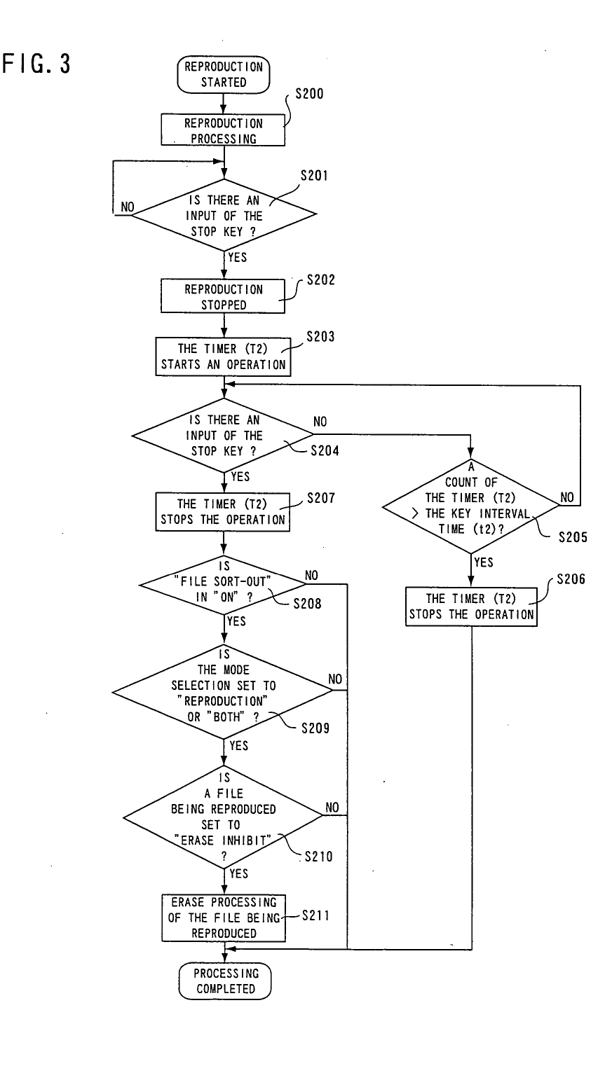

FIG. 3 shows an example of the process flow at a time when reproduction processing is executed in the HDD block 2. When the reproduction processing is executed (step S200), detection on whether or not there is a stoppage operation is executed (step S201) as with a case shown in FIG. 2, and upon detection of an input of the stop key, a reproduction operation is stopped (step S202), starting operation of the timer (T2) (step S203). After the start of the operation of the timer (T2), detection on whether or not there is an input of the stop key as the predetermined key is executed (step S204), and in case there is no input thereof, checking on whether or not a count of the timer (T2) exceeds the key interval time (t₂) is executed (step S205). In case the count does not exceed the key interval time (t₂), the processing reverts to the step (S204), thereby detecting whether or not there is the input of the stop key.

Thereafter, if the count of the timer (T2) exceeds the key interval time (t₂) without the input of the stop key, the operation of the timer (T2) is stopped (step S206), thereby completing the processing.

If the input of the stop key is detected before the count of the timer (T2) exceeds the key interval time (t₂), the operation of the timer (T2) is stopped (step S207), and checking on whether or not the file sort-out is set in “ON” is executed (step S208), completing the processing in case the same is not set to “ON”. If the same is set in “ON”, checking on whether or not the mode selection is set to “reproduction” or “both” is executed (step S209), completing the processing if not. If the mode selection is set to “reproduction” or “both”, checking on whether or not a file being currently reproduced is set to “erase inhibit” is executed (step S210), and in case the file is set to “erase inhibit”, the processing is completed as it is. If the file is not set to “erase inhibit”, erase processing of the file being currently reproduced is executed (step S211), thereby completing the processing.

In the case of this example, checking by the setting-enable time (t₁) is not executed for the reproduction processing. The process flow as described above is adopted because it is assumed that the user is likely to determine that a file will not be played back again after audio-visual playback of the file in its entirety. However, as with the case of recording, the checking by the setting-enable time (t₁) may be executed in this case as well.

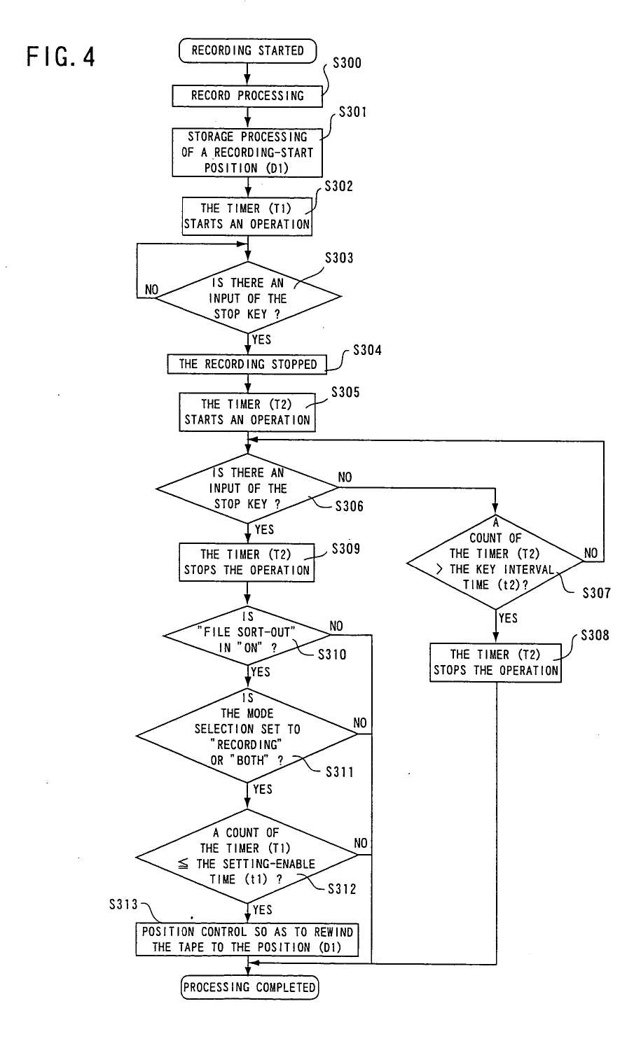

Now, FIG. 4 shows an example of the process flow at a time when videotape processing is executed in the block 1 incorporating the TV and VCR. Simultaneously with the start of the videotape processing (step S300), storage processing of a recording-start position (D1) as an index is executed (step S301), starting the operation of the timer (T1) (step S302). Then, detection on whether or not there is a stoppage operation is executed (step S303), and upon detection of an input of the stop key, recording is stopped (step S304), starting the operation of the timer (T2) (step S305). After the start of the operation of the timer (T2), detection on whether or not there is an input of the stop key as the predetermined key is executed (step S306), and in case there is no input thereof, checking on whether or not a count of the timer (T2) exceeds the key interval time (t₂) is executed (step S307). In case the count does not exceed the key interval time (t₂), the processing reverts to the step (S306), thereby detecting whether or not there is the input of the stop key.

Thereafter, if the count of the timer (T2) exceeds the key interval time (t₂) without the input of the stop key, the operation of the timer (T2) is stopped (step S308), thereby completing the processing.

If the input of the stop key is detected before the count of the timer (T2) exceeds the key interval time (t₂), the operation of the timer (T2) is stopped (step S309), and checking on whether or not the file sort-out is set to “ON” is executed (step S310), completing the processing in case the same is not set to “ON”. If the same is set to “ON”, checking on whether or not the mode selection is set to “recording” or “both” is executed (step S311), completing the processing if not. If the mode selection is set to “recording” or “both”, checking on whether or not a count of the timer (T1) is within the setting-enable time (t₁) is executed (step S312), completing the processing as it is if not. If the count of the timer (T1) is within the setting-enable time (t₁), position control is executed (S313) so as to rewind the tape to the recording-start position (D1) as stored in the step (S301), thereby completing the processing.

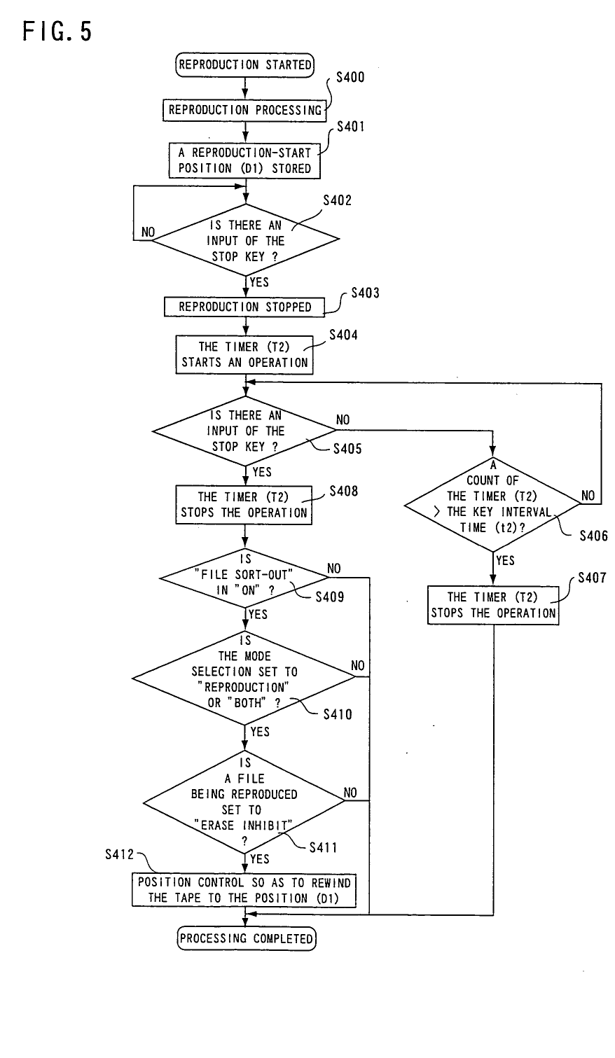

In the case of executing a reproduction processing in the block 1 incorporating the TV and VCR, a process flow is as shown in FIG. 5. When the reproduction processing is executed (step S400), storage processing of a reproduction-start position (D1) as an index is executed (step S401) as with the case shown in FIG. 4. Then, detection on whether or not there is a stoppage operation is executed (step S402), and upon detection of an input of the stop key, a reproduction operation is stopped (step S403), starting the operation of the timer (T2) (step S404). After the start of the operation of the timer (T2), detection on whether or not there is an input of the stop key as the predetermined key is executed (step S405), and in case there is no input thereof, checking on whether or not a count of the timer (T2) exceeds the key interval time (t₂) is executed (step S406). In case the count does not exceed the key interval time (t₂), the processing reverts to the step (S405), thereby detecting whether or not there is the input of the stop key.

Thereafter, if the count of the timer (T2) exceeds the key interval time (t₂) without the input of the stop key, the operation of the timer (T2) is stopped (step S407), thereby completing the processing.

If the input of the stop key is detected before the count of the timer (T2) exceeds the key interval time (t₂), the operation of the timer (T2) is stopped (step S408), and checking on whether or not the file sort-out is set to “ON” is executed (step S409), completing the processing in case the same is not set to “ON”. If the same is set to “ON”, checking on whether or not the mode selection is set to “reproduction” or “both” is executed (step S410), completing the processing if not. If the mode selection is set to “reproduction” or “both”, checking on whether or not a file being currently reproduced is set to “erase inhibit” is executed (step S411), and in case the file is set to “erase inhibit”, the processing is completed as it is. If the file is not set to “erase inhibit”, position control is executed (S412) so as to rewind the tape to the recording-start position (D1) as stored in the step (S401), thereby completing the processing.

In the process flow shown in FIGS. 4 and 5, respectively, a position where recording or reproduction is started is stored as the index, and control is executed so as to rewind the tape to the position, so that in the case of newly recording, recording is executed so as to start from a position where unnecessary contents information is recorded, thereby enabling the unnecessary contents information recorded on a videotape to be reduced as much as possible.

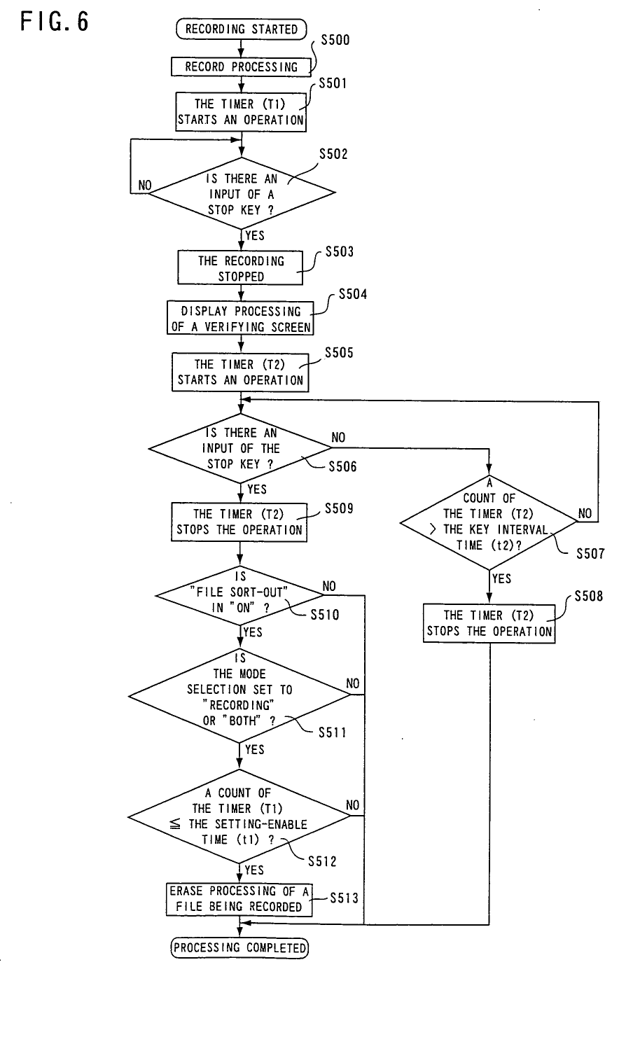

FIG. 6 shows another process flow in the case of executing videotape processing in the HDD block 2. When recording is started, simultaneously with the start of the videotape processing (step S500), the timer (T1) starts operation (step S501). Then, detection on whether or not there is a stoppage operation is executed (step S502), and upon detection of an input of the stop key, the recording is stopped (step S503) and at the same time, a verifying screen is displayed (step S504), whereupon the operation of the timer (T2) is started (step S505). At this point in time, in the case of executing erasing, a message urging the user to operate any suitable key is displayed in the verifying screen as shown in FIG. 9 by way of example. Thereafter, checking on whether or not any suitable key is inputted after the start of the operation of the timer (T2) is executed (step S506), and in case there is no input thereof, checking on whether or not a count of the timer (T2) exceeds the key interval time (t₂) is executed (step S507). In case the count does not exceed the key interval time (t₂), the processing reverts to the step (S506), thereby detecting whether or not there is the input of any suitable key.

Thereafter, if the count of the timer (T2) exceeds the key interval time (t₂) without the input of any suitable key, the operation of the timer (T2) is stopped (step S508), thereby completing the processing.

If the input of any suitable key is detected before the count of the timer (T2) exceeds the key interval time (t₂), the operation of the timer (T2) is stopped (step S509), and checking on whether or not the file sort-out is set to “ON” is executed (step S510), completing the processing in case the same is not set to “ON”. If the setting is set to “ON”, checking on whether or not the mode selection is set to “recording” or “both” is executed (step S511), completing the processing if not. If the mode selection is set to “recording” or “both”, checking on whether or not a count of the timer (T1) is within the setting-enable time (t₁) is executed (step S512), completing the processing as it is if not. If the count of the timer (T1) is within the setting-enable time (t₁), erase processing of a file being currently recorded is executed (step S513), thereby completing the processing.

With the process flow shown in FIG. 6, since the verifying screen is displayed after the detection of the stop key, urging the user to input any suitable key, the operation is rendered user-fiiendly, thereby reducing the risk of an operation mistake or erase omission committed by the user. The same process flow steps may be used in the case of the process flow shown in FIGS. 3 to 5, respectively, however, description thereof is omitted to avoid duplicated description.

In the foregoing examples, the stop key is used as the predetermined key, thereby enabling the erase processing to be executed with a simple operation, however, if an operation mistake is prone to occur, a key other than the stop key may be used as the predetermined key The predetermined key may be rendered selectable in, for example, the setting screen shown in FIG. 8. In such a case, a plurality of keys such as combination of the stop key with another key may be rendered selectable. Further, the file sort-out is executed by operating the key twice, however, another operation such as, for example, multiple pressing of the key may be adopted.

With the examples described hereinbefore, the process flow is described for the video signal recording and reproducing system combining the function block incorporating the TV and the VCR with the function block for the HDD for integration, however; it is to be pointed out that the same is similarly applicable even to the video and reproduction device for a single VCR or a single HDD.

What is claimed is:

1. A video signal recording and reproducing system comprising:
recording means for recording contents information on a recording medium;
reproduction means for executing reproduction of the contents information recorded on the recording medium;
detection means for executing detection on execution of an operation stoppage of the recording means or the reproduction means;
determination means for determining whether or not a predetermined key is operated within a predetermined time from the detection on the execution of the operation stoppage, by the detection means; and
erasing means for erasing contents information, of which recording or reproduction operation is stopped, from the recording medium on the basis of determination by the determination means that the detection has been made.

2. A video signal recording and reproducing system comprising:
recording means for recording contents information on a recording medium;
reproduction means for executing reproduction of the contents information recorded on the recording medium;
detection means for executing detection on execution of an operation stoppage of the recording means or the reproduction means;
display means for displaying a predetermined verifying screen in response to the detection on the execution of the operation stoppage by the detection means;
determination means for determining whether or not a predetermined key is operated within a predetermined time from the detection of the execution of the operation stoppage, by the detection means; and
erasing means for erasing contents information, of which recording or reproduction operation is stopped, from the recording medium on the basis of determination by the determination means that the detection has been made.

3. A video signal recording and reproducing system comprising:
recording means for recording contents information on a recording medium;
reproduction means for executing reproduction of the contents information recorded on the recording medium;
storage means for storing information on a recording position where the recording means or reproduction means have started operation;
detection means for executing detection on execution of an operation stoppage of the recording means or the reproduction means;
determination means for determining whether or not a predetermined key is operated within a predetermined time from the detection of the execution of the operation stoppage, by the detection means; and
position control means for controlling such that the recording medium is set to an operation position corresponding to the information on the recording position on the basis of determination by the determination means that the detection has been made.

4. A video signal recording and reproducing system comprising:
recording means for recording contents information on a recording medium;
reproduction means for executing reproduction of the contents information recorded on the recording medium;
storage means for storing information on a recording position where the recording means or reproduction means have started operation;
detection means for executing detection on execution of an operation stoppage of the recording means or the reproduction means;
display means for displaying a predetermined verifying screen in response to the detection on the execution of the operation stoppage by the detection means;
determination means for determining whether or not any suitable key is operated within a predetermined time from the detection of the execution of the operation stoppage, by the detection means; and
position control means for controlling such that the recording medium is set to an operation position corresponding to the information on the recording position on the basis of determination by the determination means that the detection has been made.

5. A video signal recording and reproducing system according to claim 1, wherein the detection means execute the detection of operation of a plurality of keys specifically combined as the predetermined key.

6. A video signal recording and reproducing system according to any of claim 1, wherein the determination means execute determination processing in the case where the detection means execute the detection on the execution of the operation stoppage, within a predetermined operation time from the start of operation by the recording means or the reproduction means.
